(19) United States
(12) Patent Application Publication
(10) Pub. No.: US 2023/0214906 A1
(43) Pub. Date: Jul. 6, 2023

(54) INTEGRATED DIGITAL MARKETPLACE

(71) Applicant: Qathena, Inc., San Francisco, CA (US)

(72) Inventor: Minh CHAU, Newark, CA (US)

(73) Assignee: Qathena, Inc., San Francisco, CA (US)

(21) Appl. No.: 18/051,461

(22) Filed: Oct. 31, 2022

Related U.S. Application Data
(60) Provisional application No. 63/263,325, filed on Oct. 29, 2021.

(51) Int. Cl. G06Q 30/0601; G06Q 30/0283; G06Q 10/0835

(52) U.S. Cl. CPC G06Q 30/0635; G06Q 30/0283; G06Q 10/0835

(57) ABSTRACT

Systems and methods for consolidated ordering are provided. The systems and methods for consolidated ordering may allow merchants to list products for sale and allow users to select products from multiple merchants to be included in a single order, pay for the order, and pick-up the order or receive the order in a single delivery. The systems and methods for consolidated ordering may also determine fees associated with the order, apportion the fees between the user and merchants associated with the order, and apportion payment of the order between the merchants associated with the order. Additionally, the systems and methods for consolidated ordering may determine order preparation instructions for the merchants, pick-up instructions for users, and delivery instructions for delivery services.

### CROSS-REFERENCE TO RELATED APPLICATIONS

This application claims the benefit of the priority date from U.S. Provisional Application No. 63/263,325, filed on Oct. 29, 2021, the entire contents of which are hereby expressly incorporated by reference into this disclosure as if set forth fully herein.

### BACKGROUND OF THE INVENTION

Merchants may offer products for sale using different types of ordering systems. For example, merchants can offer products for sale via websites, mobile applications, or over the phone. Merchants can also provide delivery services for orders. For example, merchants can provide their own delivery services or work with delivery service companies to deliver orders. However, ordering systems and delivery services are not available for orders including products from multiple merchants. A customer may have to complete a unique order and have a separate pick-up or delivery for orders from each merchant.

### SUMMARY OF THE INVENTION

The needs described above, as well as others, are addressed by embodiments of systems and methods for consolidated ordering. The consolidated orders may include products ordered from multiple merchants. The systems and methods for consolidated ordering may allow merchants (e.g., restaurants, convenience stores, retail stores, etc.) to list products for sale and allow users to select products from multiple merchants to be included in a single order, pay for the order, and receive the order in a single delivery. The systems and methods for consolidated ordering may also determine fees associated with the order, apportion the fees between the merchants associated with the order, and apportion payment of the order between the merchants associated with the order. Additionally, the systems and methods for consolidated ordering may determine order preparation instructions for the merchants and delivery instructions for delivery services.

In an aspect, a method for facilitating a consolidated order from a plurality of merchants is provided. The method may include providing a user interface including: a first user interface view, the first user interface view including a first input for selecting a first product provided from a first merchant, and a second user interface view, the second user interface view including a second input for selecting a second product provided from a second merchant; receiving a first selection of the first input; in response to the first selection, adding the first product to an order; receiving a second selection of the second input; in response to the second selection, adding the second product to the order; determining a total cost for the order; requesting payment for the total cost of the order; receiving a payment for the total cost of the order; in response to receiving the payment: sending instructions for the order to be fulfilled, by the first merchant and the second merchant, and sending delivery instructions for the products included in the order to be retrieved, by a delivery person, the delivery instructions including retrieving the first product from a first location where the first merchant is located and retrieving the second product from a second location where the second merchant is located; disbursing a first portion of the payment to the first merchant; and disbursing a second portion of the payment to the second merchant. The method may further include receiving a request for to access a consolidated ordering system, wherein providing the user interface is in response to receiving the request. The method may also include, based on the products included in the order: determining the first portion of the payment for the first merchant; and determining the second portion of the payment for the second merchant.

In an example implementation, the method includes determining a fee associated with the order; subtracting a first portion of the fee from the first portion of the payment prior to disbursing the first portion of the payment to the first merchant; and subtracting a second portion of the fee from the second portion of the payment prior to disbursing the second portion of the payment to the second merchant. In some embodiments, the first portion of the fee and the second portion of the fee are equivalent. In an example, the fee includes a user fee, a first merchant fee, and a second merchant fee. In example embodiments, sending instructions for the order to be fulfilled comprises: instructing the first merchant to prepare the first product; and instructing the second merchant to prepare the second product. In an example, the first location and the second location are the same location.

The method may include displaying merchant buttons for the merchants, the merchant buttons selectable to cause only products associated with a selected merchant associated with a selected merchant button to be displayed. In example implementations, the merchant buttons include: a first merchant button associated with the first merchant, the first merchant button selectable to provide the first user interface view; and a second merchant button associated with the second merchant, the second merchant button selectable to provide the second user interface view.

In another aspect, a system for facilitating a consolidated order from a plurality of merchants is provided. The system may include at least one processing device and at least one memory device, the memory device storing data instructions that, when executed by the at least one processing device, cause the at least one processing device to: display on a computing device a consolidated order interface comprising: a merchant button for each of a plurality of merchants, the merchant buttons selectable to cause a user device to display one or more product buttons, the product buttons associated with products of the selected merchant and selectable to add products to an order, and an order button that is selectable to cause the user device to display an order interface comprising a list of selected products and a payment button to initiate a transaction for the selected products; receive input selecting a first merchant button associated with a first merchant; display a first product button associated with a first product of the first merchant in response to receiving the input selecting the first merchant button;

receive input selecting the first product button; add the first product to the order in response to the input selecting the first product button; receive input selecting a second merchant button associated with a second merchant; display a second product button associated with a second product of the second merchant in response to receiving the input selecting the second merchant button; receive input selecting the second product button; add the second product to the order in response to the input selecting the second product button; receive a payment for the order; and send instructions for the order to be fulfilled in response to receiving the payment. The consolidated order interface may further comprise one or more product type buttons that are selectable to cause the user device to display the product buttons associated with products of a selected product type. The at least one processing device may be further configured to: send delivery instructions for the products included in the order to be retrieved, by a delivery person, the delivery instructions including retrieving the first product from a first location where the first merchant is located and retrieving the second product from a second location where the second merchant is located. The at least one processing device may be further configured to: disburse a first portion of the payment to the first merchant; and disburse a second portion of the payment to the second merchant. In some embodiments, the at least one processing device is further configured to: determine a fee associated with the order; subtract a first portion of the fee from the first portion of the payment prior to disbursing the first portion of the payment to the first merchant; and subtract a second portion of the fee from the second portion of the payment prior to disbursing the second portion of the payment to the second merchant. The fee may include any one of (i) a service fee, (ii) a community service fee, (iii) a platform service fee, (iv) a credit card fee, or (v) any combination of (i)-(iv). To send instructions for the order to be fulfilled may comprise to: instruct the first merchant to prepare the first product; and instruct the second merchant to prepare the second product.

In certain embodiments, the at least one processing device is further configured to: receive a request, from the computing device, to access a consolidated ordering system, wherein to display on the computing device the consolidated order interface is in response to receiving the request. The at least one processing device may be further configured to: display a merchant user interface on a first merchant device associated with the first merchant, the merchant user interface device comprising one or more product type lists; and receive a request to add the first product button to one of the one or more product type lists, wherein display the first product button is in response to the request to add the first product button. The merchant user interface may further comprise: an operating days element including day buttons selectable to select days of operation; and an operating times element including time buttons selectable to select hours of operation.

The above presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF DRAWINGS

The accompanying drawings, which are incorporated in and constitute a part of this disclosure, illustrate various embodiments of the present disclosure. In the drawings:

FIG. 1 is a block diagram of an operating environment for providing a consolidated ordering system;

FIG. 2 is flow chart of a method for providing consolidated ordering;

FIG. 3 is a merchant user interface;

FIG. 4 is a user interface for consolidated ordering;

FIG. 5 is a diagram of a consolidated order cost determination; and

FIG. 6 is a block diagram of a computing device.

### DETAILED DESCRIPTION OF THE INVENTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

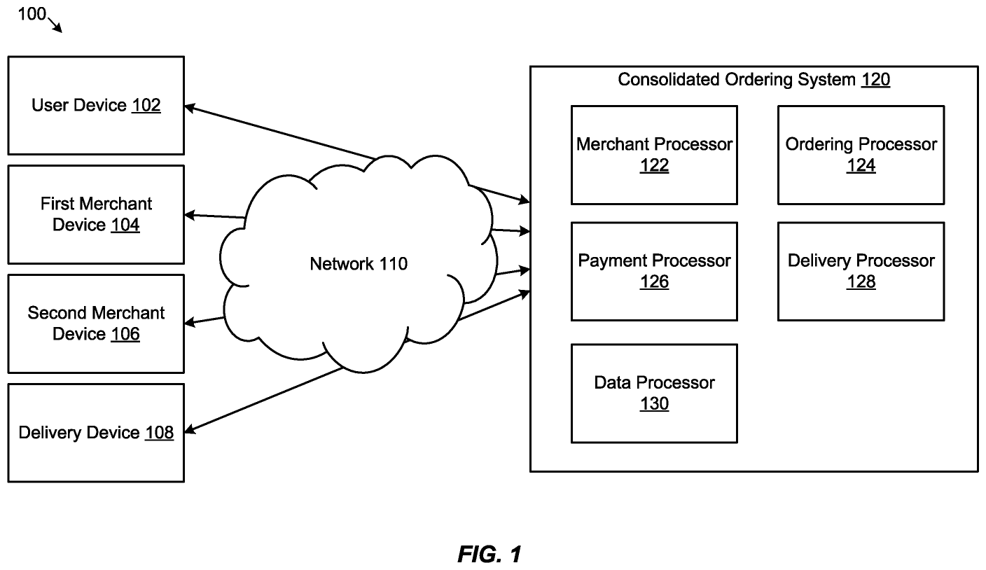

FIG. 1 is a block diagram of an operating environment 100 for providing a consolidated ordering system 120. The operating environment 100 may include a user device 102, a first merchant device 104, a second merchant device 106, a delivery device 108, and the consolidated ordering system 120. The operating environment 100 may include more or less devices in additional embodiments. For example, the operating environment 100 may include more user devices, more merchant devices, and/or more delivery devices. In an example implementation, there are additional merchant devices associated with additional merchants that may list products for consolidated orders and/or the same merchants associated with the first merchant device 104 and/or the second merchant device 106. The network 110 may be any network, including an intranet, the Internet, a cellular network, a local area network, a wide area network, and/or any other network.

The first merchant device 104 may be a computing device associated with a first merchant that is registered with or otherwise uses the consolidated ordering system 120. The first merchant may be a single vendor (e.g., a restaurant, a retail store, etc.) or an entity associated with multiple vendors (e.g., an entity associated with a mall, a strip mall, a food hall, a ghost kitchen, etc.). The first merchant device 104 may add products for sale, set the price of products, adjust the price of products, set dynamic pricing based on demand and/or time, set times of operation, receive orders, receive order instructions, send order status updates (e.g., order being prepared, ordering being delivered to pick-up location, order ready for pick-up, order picked-up), and/or perform other operations for consolidated ordering. The first merchant device 104 may communicate with the consolidated ordering system 120, via the network 110 for example, to perform the consolidated order operations. The first merchant may interact with or otherwise operate the first merchant device 104 to cause the first merchant device 104 to cause the first merchant device 104 to perform the consolidated order operations.

Similarly, the second merchant device 106 may be a computing device associated with a second merchant that is registered with or otherwise uses the consolidated ordering system 120. The second merchant may also be a single vendor or an entity associated with multiple vendors. The second merchant device 106 may add products for sale, set the price of products, adjust the price of products, set dynamic pricing based on demand and/or time, set times of operation, receive orders, receive order instructions, send order status updates (e.g., order being prepared, ordering being delivered to pick-up location, order ready for pick-up, order picked-up), and/or perform other operations for consolidated ordering. The second merchant device 106 may communicate with the consolidated ordering system 120, via the network 110 for example, to perform the consolidated order operations. The second merchant may interact with or otherwise operate the second merchant device 106 to cause the second merchant device 106 to cause the first merchant device 104 to perform the consolidated order operations.

The first merchant and the second merchant may be part of a community that allows consolidated ordering between merchants of the community. The community may be a location, such as a mall, a food hall, or the like. The community may charge the merchants that are part community fees for consolidated orders to be part of the community.

The first merchant device 104 and/or the second merchant device 106 may also perform operations to customize user interface views associated with the merchants. For example, the first merchant device 104 and/or the second merchant device 106 may select text for products, product descriptions, merchant name, merchant address, merchant contact information, social media links, and/or any other text and select fonts for the products, product descriptions, merchant name, merchant address, merchant contact information, social media links and/or any other text included in the user interface. The first merchant device 104 and/or the second merchant device 106 may also add logos, pictures, and/or other decorative features to the user interfaces. The first merchant device 104 and/or the second merchant device 106 can select themes for the user interface, select colors for elements of the user interface, position elements of the user interface, set background colors, set title colors, and/or the like.

In example implementations, the merchant is an entity associated with multiple vendors. In these implementations, the merchant may invite the vendors to register as merchants with the consolidated ordering system 120, edit days the vendors are open, set order times, add product types, and/or the like.

The user device 102 may be a computing device associated with a user. The user device 102 may receive from the consolidated ordering system 120 and display a consolidated ordering interface for the user to view merchants and products, select products for consolidated orders (e.g., an order that includes one or more products from the first merchant and one or more products from the second merchant), alter selected products (e.g., adding toppings to food, adding sauce to food, removing ingredients from food, etc.), place consolidated orders, pay for consolidated orders, select pick-up or delivery, select pick-up option (e.g., in store, curbside, vending machine), and/or perform other operations for consolidated ordering. The user device 102 may communicate with the consolidated ordering system 120, via the network 110 for example, to perform the consolidated order operations. The user may interact with or otherwise operate the user device 102 to cause the user device 102 to perform the consolidated order operations.

The delivery device 108 may be a computing device associated with a delivery person that is registered with or otherwise associated with the consolidated ordering system 120. The delivery device 108 may receive delivery instructions, select pick-up option, send pick-up confirmation, send delivery confirmation, and/or perform other operations associated with consolidated ordering. The delivery instructions may include one or more pick-up times, one or more pick-up locations (e.g., merchant location, pick-up area, vending machine, curbside, etc.), one or more delivery times, one or more delivery locations, and/or the like. The delivery device 108 may communicate with the consolidated ordering system 120, via the network 110 for example, to perform the consolidated order operations. The delivery person may interact with or otherwise operate the delivery device 108 to cause the delivery device 108 to perform the consolidated order operations.

In some embodiments, the user device 102 may select an option for the user to pick-up the order instead of having the order delivered. In this example, the delivery device 108 may not receive anything from the consolidated ordering system, and the user device 102 may receive pick-up instructions. The pick-up instructions may include one or more pick-up locations and one or more pick-up times for the products for the user to retrieve the order.

The user device 102, the first merchant device 104, the second merchant device 106, and/or the delivery device 108 may access the consolidated ordering system 120 (e.g., accessing the user interfaces of the consolidated ordering system 120) accessing a webpage, application, and/or some other platform hosted or otherwise maintained by the consolidated ordering system 120. The user device 102, the first merchant device 104, the second merchant device 106, and/or the delivery device 108 may access the platforms by entering a Uniform Resource Locator into a web browser, downloading and using an application, scanning a QR code, and/or some other method for accessing the consolidated ordering system 120. The user device 102, the first merchant device 104, the second merchant device 106, and/or the delivery device 108 may all be associated with accounts for the consolidated ordering system 120. The user, the first merchant, the second merchant, and/or the delivery person may create an account when accessing the consolidated ordering system 120 for the first time. Creating the account may include selecting a user type (e.g., user, merchant, delivery person) for the consolidated ordering system 120 to classify the type of device the user device 102, the first merchant device 104, the second merchant device 106, and/or the delivery device 108 are. Thus, the consolidated ordering system 120, may determine which user interfaces to display on the devices communicating with the consolidated ordering system 120.

The consolidated ordering system 120 may include a merchant processor 122, an ordering processor 124, a payment processor 126, a delivery processor 128, and a data processor 130. The merchant processor 122 may cause a merchant user interface to be displayed on the first merchant device 104 and/or the second merchant device 106. The merchant user interface may allow the first merchant device 104 and/or the second merchant device 106 to add products for sale, remove products for sale, set and/or adjust the price of products, receive orders, accept orders, receive order instructions, and/or the like. The merchant processor 122 may receive inputs or other communications from the first merchant device 104 and/or the second merchant device 106 to add the products for sale, remove the products for sale, set and/or adjust the price of products, receive acceptance for orders and/or the like. The merchant processor 122 may send communications to the first merchant device 104 and/or the second merchant device 106 to send orders, send order instructions, and/or the like.

The merchant processor 122 may also provide the first merchant device 104 and/or the second merchant device 106 with scheduled order capabilities. For example, the first merchant device 104 and/or the second merchant device 106 may select dates and times that specific products will be offered, and users (e.g., via the user device 102) can set orders to be executed at the future dates and times. The merchant processor 122 may additionally provide the first merchant device 104 and/or the second merchant device 106 with recurring order capabilities. For example, the first merchant device 104 and/or the second merchant device 106 may receive recurring orders to be executed periodically (e.g., every week, every month). The first merchant device 104 and/or the second merchant device 106 may set a subscription fee for the recurring orders, and the consolidated ordering system 120 can execute the orders periodically and request the subscription fee from the user (e.g., from the user device 102).

The ordering processor 124 may cause a user interface to be displayed on the user device 102. The user interface may allow the user device 102 to view merchants and products, select products for a consolidated order, place consolidated orders, pay for consolidated orders, and/or perform other operations for consolidated ordering. The ordering processor 124 may receive inputs or other communications from the user device 102 to receive requests to display merchants and products, receive selections of products for a consolidated order, receive a request to complete a consolidated order, and/or other communications associated with consolidated ordering. The ordering processor 124 may send communications to the user device 102 to send a request for payment, send order confirmation, send order completion confirmation, and/or other communications associated with consolidated ordering.

The ordering processor 124 may restrict or otherwise determine which merchants the user device 102 may add products from for an order. For example, the consolidated ordering system 120 may determine which merchants and associated products to display to the user device 102. In some embodiments, the ordering processor 124 may receive a location from the user device 102 and determine merchants within an area of the location to display to the user device for selecting products for orders. Additionally, the ordering processor 124 may determine which merchants can be included in the same consolidated order. For example, the ordering processor 124 may require that merchants in a consolidated order be within an area of each other so a delivery person can pick-up every product in a consolidated order in a threshold amount of time (e.g., the ordering processor 124 requires merchants to be within 5 miles of each other merchant in the consolidated order, the ordering processor 124 requires merchants to be at the same location, such as a food hall or mall, to be in the same consolidated order).

The payment processor 126 may process payments for consolidated orders, determine fees for consolidated orders, determine payment allocations to merchants (e.g., the first merchant and the second merchant, determine the selected tip, and/or the like. The tip may be for the merchants associated with the consolidated order and/or the delivery person. The payment processor 126 may communicate with the merchant processor 122 to determine payment allocations for merchants, subtract fees from payment allocations, send payment allocations, and/or the like. The payment processor 126 may communicate with the ordering processor 124 to determine payments for consolidated orders, process payments for consolidated orders, determine the selected tip, and/or the like.

The payment processor 126 may determine fees for the user making the order and/or fees for the merchants involved in the order. The fees may be fees for using the consolidated ordering system 120 to complete the consolidated order (e.g., service fees, delivery fees, processing fees), fees for payment type (e.g., credit card fees), fees for the number of merchants, and/or the like. In some embodiments, the payment processor 126 may determine the fees based on the price of the consolidated order, the merchants associated the consolidated order, and/or the like. For example, the payment processor 126 may determine a service fee for the user, a processing fee for the merchants, and a fee for the number of merchants. The processing fee may vary for the merchants. The fee for the number of merchants may be a flat fee (e.g., $0.00 for a single merchant and $0.10 for each additional merchant). The payment processor 126 may determine the service fee and the processing fee, add the service fee and processing fee to the total cost of the order, receive payment from the user device 102 for the total cost of the order, determine an allocation of the payment for the merchants associated with the order, subtract the fees (e.g., the service fee and processing fees) from the allocations, and send the allocations to the merchants. In other embodiments, the payment processor 126 adds only the service fee to the total cost of the order and subtracts the service fee and processing fees from the allocations sent to the merchants associated with the order. Thus, the merchants pay the processing fees by having the processing fees subtracted from the disbursements the merchant receive.

The payment processor 126 may determine the service fee based on the total of the order. In an example implementation, the payment processor 126 determines a flat fee for totals below a threshold (e.g., $1.49 service fee if the total is lower than $15) and determines a variable fee for totals above the threshold (e.g., a 7.5% fee if the total is greater than $15). The processing fee may also be a flat fee or a variable fee. The merchants may negotiate or otherwise select the processing fee to be applied when the merchants are involved in a consolidated order. For example, the consolidated ordering system 120 provides the merchant devices options to select processing fees the merchants will pay for consolidated orders. In an example implementation, the payment processor 126 determines the processing fee for the first merchant and the second merchant is a variable fee (e.g., 2.9% of the total plus $0.30).

In some embodiments, the payment processor 126 may determine when the payment for a consolidated order is due. For example, some merchants may allow a user to select payment when the order is placed, payment when the order is picked-up, payment when the order is delivered, and/or at some other point during the consolidated ordering process. In example implementations, some merchants may not accept payment through the consolidated ordering system 120, and the consolidated ordering system 120 may instruct the user device 102 that payment will be accepted at pick-up for user pick-up orders. For delivery orders, the consolidated ordering system 120 may instruct the delivery device 108 for the delivery person to pay for the order at pick-up. The consolidated ordering system 120 may reimburse the delivery device 108 for the payment at pick-up once the payment is made to the merchant. The payment processor 126 may communicate with the ordering processor 124 to request the user's name, phone number, and/or email address from the user device when the payment is accepted at pick-up by the user and/or the delivery person.

The delivery processor 128 may determine product preparation instructions for consolidated orders, determine delivery instructions, determine the delivery method, and/or the like. The delivery processor 128 may communicate with the ordering processor 124 to determine when a consolidated order is placed and the products in the consolidated order. The delivery processor 128 may determine the merchants associated with a placed consolidated order, and the delivery processor may communicate with the merchant processor 122 to cause the merchant processor 122 to send product preparation instructions to the associated merchants (e.g., sending instruction prepare food, package products, place the products in a pick-up area, etc. to the first merchant device 104 and/or the second merchant device 106). The delivery processor 128 may communicate with the delivery device 108 to cause the delivery device 108 to display a delivery user interface. The delivery user interface may display delivery instructions for the delivery person, including pick-up times and locations, delivery times and locations, a product list for the consolidated order, and/or the like.

The data processor 130 may collect, organize, store, and/or process data associated with consolidated ordering using the consolidated ordering system. The data processor 130 may collect data and organize and store the data as a graph. The graph may include vertices (e.g., merchants, merchant addresses, merchant localities including city and country, users, order, transactions, items in an order, day of the week the order was made, month the order was made, year the order was made, etc.) and edges (e.g., connections between merchants and the merchant location, localities, customers, connections between locations and orders and user, connections between users and visited locations, transactions, payments, and purchased items, connections between orders and day of the week the order was made, month the order was made, year the order was made, connections between products and day of the week the order was made, month the order was made, year the order was made, etc.).

The data processor 130 may receive queries (e.g., from an operator of the consolidated ordering system 120, the first merchant, the second merchant, etc.) including queries for determining popular products, determining merchant revenue, determining location revenue, users per merchant, users with types of information per merchant, and/or other queries for data analysis and/or review. For example, the data processor 130 may determine popular items by traversing one or more created graphs to identify ordered items and the number of times the items were ordered. The data processor 130 may determine popular items by location for a merchant by traversing all locations associated with the merchant, traversing down to all orders transacted in the locations, traversing down to all products associated with the orders, and determining the number of times each product was ordered. Therefore, a merchant may gain insights into popular products and/or the associated user interface set up (e.g., product placement on a user interface).

To determine the revenue per location by year, the data processor 130 may traverse one or more created graphs and traverse down to all locations per merchant, travers down to all payments in a location, filter by the desired year, and determine the total revenue from all of the payments. To determine users with email and/or phone numbers stored per merchant, the data processor 130 may traverse one or more graphs and traverse down to all users associated with a merchant (e.g., purchased a product from the merchant), identify the stored user information, and determine which users have stored email addresses and/or phone numbers. Therefore, merchants may identify which users the merchant may contact for advertising and/or additional business purposes.

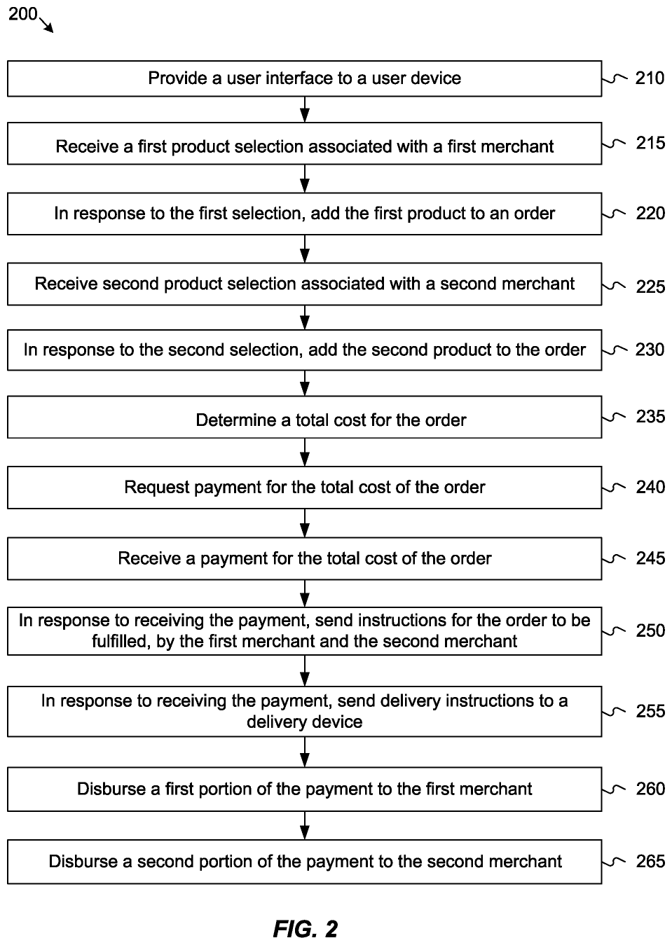

FIG. 2 is flow chart of a method 200 for providing consolidated ordering. The method 200 may begin at operation 210, and a user interface may be provided to a user device. For example, the consolidated ordering system, via the ordering processor 124 for example, communicates with the user device 102 to cause the user device to display the user interface. The user interface may include multiple views based on user input. The user interface may include views displaying products from multiple merchants, views displaying products for a single merchant, views displaying products associated with a selected product type, and/or the like. For example, the user interface includes a first user interface view, the first user interface view including a first input for selecting a first product provided from a first merchant, and a second user interface view, the second user interface view including a second input for selecting a second product provided from a second merchant. The user may select merchant buttons the user device 102 displays, and the ordering processor 124 may cause the user device 102 to display products of the merchant associated with the selected merchant button.

In operation 215, a first product selection associated with a first merchant may be received. For example, the consolidated ordering system 120 receives a first selection of a product of the first merchant from the user device 102. The user device 102 may display a user interface with selectable buttons for products associated with the first merchant, and the user may make the first product selection using the user interface displayed by the user device 102. For example, the user makes a first selection of the first input for selecting the first product provided by the first merchant. In response to the first selection in operation 215, the first product is added to an order in operation 220. For example, the consolidated ordering system 120 may add the first product to an order in response to receiving the selection from the user device 102.

In operation 225, a second product selection associated with a second merchant may be received. For example, the consolidated ordering system 120 receives a second selection of a product of the second merchant from the user device 102. The user device 102 may display a user interface with selectable buttons for products associated with the second merchant, and the user may make the second product selection using the user interface displayed by the user device 102. For example, the user makes a first selection of the second input for selecting the second product provided by the second merchant. In response to the first selection in operation 225, the second product is added to the order in operation 230. For example, the consolidated ordering system 120 may add the second product to the order in response to receiving the selection from the user device 102.

In operation 235, a total cost for the order may be determined. For example, the consolidated ordering system 120 (e.g., via the payment processor 126) may determine a total cost for the order. The consolidated ordering system may determine the total cost by determining the price of the first product and the second product, determining taxes, determining the fees, and determining any other cost associated with the consolidated order.

In operation 240, payment for the total cost of the order may be requested. For example, the consolidated ordering system 120 may send a request for payment of the total cost of the order to the user device 102. The request may include causing the user device 102 to display a payment user interface. The payment user interface may include a list of the products in the order, the price of the products, the taxes, the fees, any other cost included in the total cost of the order, and/or a payment element for paying the total cost.

In operation 245, a payment may be received for the total cost of the order. For example, the user device 102 completes the payment (e.g., using inputs via the payment user interface displayed by the user device 102), and the consolidated ordering system 120 receives the payment. The payment processor 126 may process the payment and send a payment confirmation to the user device 102.

In response to receiving the payment, instructions for the order to be fulfilled by the first merchant and the second merchant may be sent in operation 250. For example, the consolidated ordering system 120 (e.g., via the merchant processor 122) may send instructions to the first merchant device 104 and the second merchant device 106 for the order to be fulfilled by the first merchant and the second merchant. The instructions may include the list of products to prepare for pick-up by a delivery person, the time the products should be prepared, where to position the products for pick-up, and/or any other information for the merchants to prepare the order.

In some embodiments, the first merchant and/or the second merchant may have multiple employees, and the instructions for the order to be fulfilled may be sent to more than one employee. For example, the first merchant may be a restaurant, and the consolidated order includes a food product the first merchant offers. The consolidated ordering system 120 may send the instructions to the first merchant device 104 and/or other merchant devices associated with the first merchant. For example, a merchant device associated with the kitchen may receive instructions to cook the food product, and a merchant device associated with wait staff may receive instructions to bring the food product to a location once the kitchen cooks the food product.

In response to receiving the payment, delivery instructions to a delivery device are sent in operation 255. For example, the consolidated ordering system 120 (e.g., via the delivery processor 128) sends delivery instructions to the delivery device 108. The delivery instructions may include instructions for the products included in the order to be retrieved, by a delivery person, the delivery instructions including retrieving the first product from a first location where the first merchant is located and retrieving the second product from a second location where the second merchant is located. In example implementations, the first location and the second location are the same location. For example, the first merchant and the second merchant may be located in the same location (e.g., a mall, a food hall, a strip mall, etc.), and the first merchant and the second merchant may position the products in the same place for retrieval by the delivery person.

In operation 260, a first portion of the payment may be disbursed to the first merchant. For example, the payment processor 126 may determine a first allocation of the payment to be sent to the first merchant, subtract any fees from the allocation, and cause the first portion of the payment to be sent to the first merchant device 104.

In operation 265, a second portion of the payment may be disbursed to the second merchant. For example, the payment processor 126 may determine a second allocation of the payment to be sent to the second merchant, subtract any fees from the allocation, and cause the second portion of the payment to be sent to the second merchant device 106.

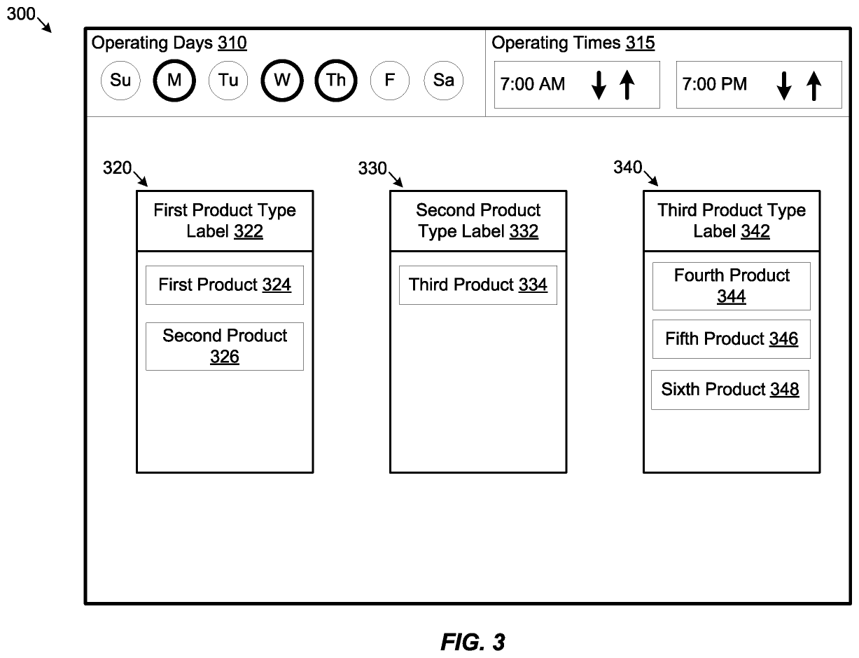

FIG. 3 is a merchant user interface 300. The consolidated ordering system 120 may cause the first merchant device 104 and/or the second merchant device 106 to display the merchant user interface 300. The first merchant and/or the second merchant may interact with the merchant user interface 300 using the first merchant device 104 and the second merchant device 106, respectively.

The merchant user interface 300 may include an operating days element 310, an operating times element 315, a first product type list 320, a second product type list 330, and a third product type list 340. The merchant user interface 300 may include additional features in other embodiments, such as a user interface editing element to adjust logos, text, and/or the like for the user interface associated with the merchant (e.g., the user interface displayed by the user device 102 when the user selects the merchant button associated with the merchant).

The operating days element 310 includes day buttons for the merchant to select days of operation. In this example, the merchant has selected Monday, Wednesday, and Thursday. The operating times element 315 includes time buttons for the merchant to select hours of operation. The merchant has selected 7:00 AM to 7:00 PM in this example.

The first product type list 320, the second product type list 330, and the third product type list 340 include products the merchant wants to offer for sale, and the merchant can add products, remove products, and set the price of the products using the first product type list 320, the second product type list 330, and the third product type list 340. The first product type list 320 includes a first product type label 322, a first product 324, and a second product 326. The second product type list 330 includes a second product type label 332 and a third product 334. The third product type list 340 includes a third product type label 342, a fourth product 344, a fifth product 346, and a sixth product 348. The merchant can set the first product type, the second product type, and/or the third product type (e.g., for a restaurant, the product types may include appetizers, main courses, salads, desserts, etc.) using the first product type label 322, the second product type label 332, and the third product type label 342, respectively. The merchant may add product titles, product descriptions, and/or product images using the first product 324, the second product 326, the third product 334, the fourth product 344, the fifth product 346, and/or the sixth product 348. The merchant may add or remove products from the first product type, the second product type, and/or the third product type. The merchant may also create or remove product types.

In some embodiments, the merchant may upload a preexisting product list (e.g., a menu, an inventory list) to the consolidated ordering system 120, and the consolidated ordering system 120 may automatically add the products in the product list to be associated with the merchant. For example, the merchant may upload an image, a document, or some other file with the preexisting product list. The consolidated ordering system 120 may use optical character recognition or some other character recognition process to identify the products in an image or other file. The consolidated ordering system 120 may request information from the merchant if the consolidated ordering system 120 does not identify all of the information in the provided file.

In an example implementation, the merchant is an entity associated with multiple vendors. Therefore, the merchant may add products from multiple vendors to be included in the first product type, the second product type, and/or the third product type. For example, the merchant may select popular products from the multiple vendors to be included in user interfaces for consolidated ordering, displayed by the user device 102 for example.

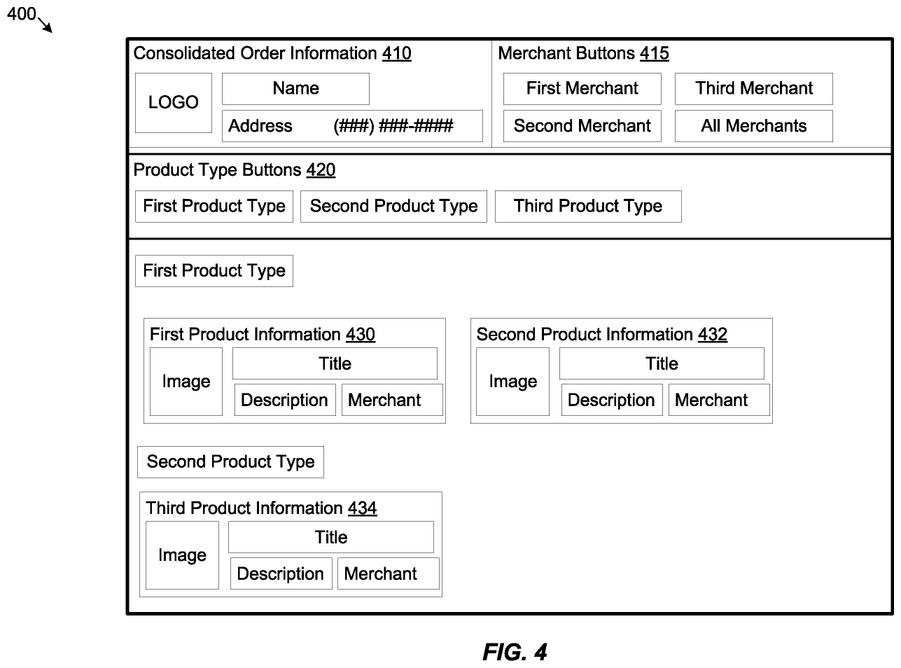

FIG. 4 is a user interface 400 for consolidated ordering. The consolidated ordering system 120 may cause the user device 102 to display the user interface 400. The user may operate the user device 102 to interact with the user interface 400. The user interface 400 may include consolidated order information 410, merchant buttons 415, product type button 420, first product information 430, second product information 432, and third product information 434. The first product information 430, the second product information 432, and the third product information 434 may be product buttons selectable to add the associated product to an order.

The consolidated order information 410 may include information associated with consolidated ordering, such as a logo, a name, and address, and a phone number. The consolidated order information may be associated with an entity associated with the multiple merchants.

The merchant buttons 415 may be selectable to cause the user interface 400 to display products of the merchant associated with the selected button. In this example, the first merchant, the second merchant, a third merchant, or all merchants may be selected. In example implementations, multiple merchants may be selected at once (e.g., the first merchant and the second merchant selected).

The product type buttons 420 may be selectable to cause the user interface 400 to display products associated with the selected product type. In this example, a first product type, a second product type, and a third product type may be selected. The first product type, the second product type, and the third product type may correspond to the first product type list 320, the second product type list 330, and the third product type list 340, respectively. In example implementations, multiple product types may be selected at once (e.g., the first product type and the second product type).

The first product information 430, the second product information 432, and the third product information 434 may include product information including images, a title, a description, the merchant associated with the product, and/or other information for example. The first product information 430, the second product information 432, and the third product information 434 may be selectable to add the associated product to an order. The first product information 430, the second product information 432, and the third product information 434 may correspond to the first product 324, the second product 326, and the third product 334, respectively.

The user interface 400 may include additional elements in some embodiments. For example, the user interface may include a user page for setting user information and payment methods, a past order element to review previous orders, a search feature, a location setting feature, and/or the like.

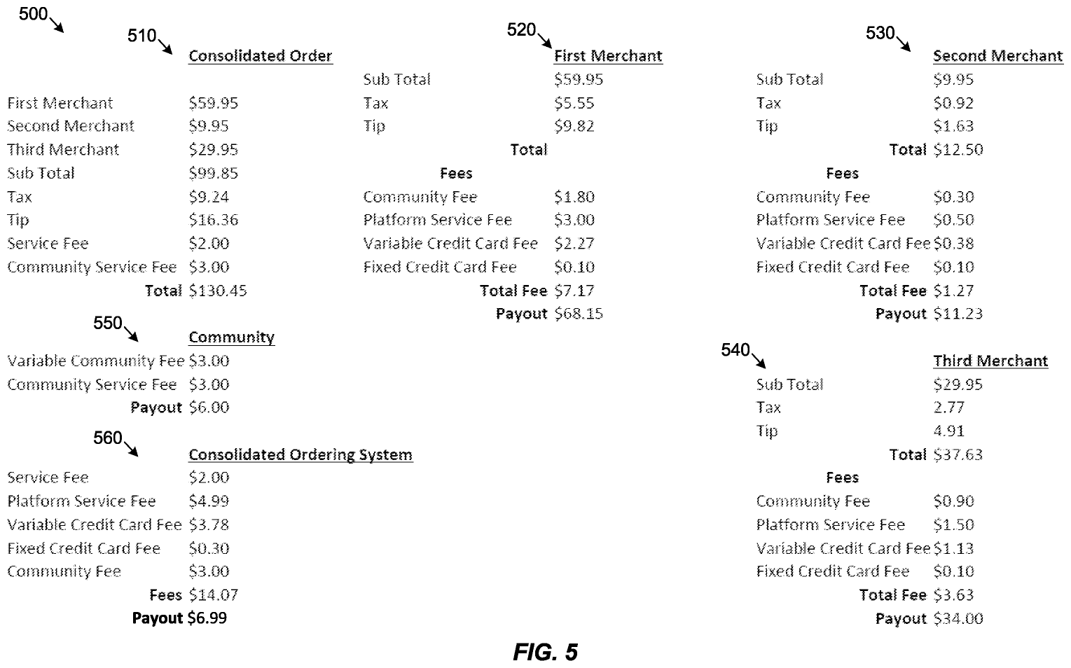

FIG. 5 is a diagram 500 of a consolidated order cost determination. The consolidated order cost determination may be a determination for an order involving a first merchant, a second merchant, and a third merchant. The first merchant, the second merchant, and the third merchant may be part of a community that charges the merchants to complete consolidated orders and charges users to complete consolidated orders with merchants in the community. The diagram 500 may include a consolidated order section 510, a first merchant section 520, a second merchant section 530, a third merchant section 540, a community section 550, and a consolidated ordering system section 560.

The consolidated order section 510 may include the total cost of the consolidated order that the user will pay. The total cost of the consolidated order may include the cost of the products from the first merchant, the second merchant, and the third merchant, the tax, the tip, and fees. In this example, the user is charged a service fee for the consolidated ordering system 120 and a community service fee for the community. The service fee is a fixed fee for the consolidated ordering system 120 in this example.

The first merchant section 520 may include the cost of the products included in the consolidated order for the first merchant, the tax for the products, the tip for the first merchant, the portion of fees to be paid by the first merchant, and the payout to the first merchant. The second merchant section 530 may include the cost of the products included in the consolidated order for the second merchant, the tax for the products, the tip for the second merchant, the portion of fees to be paid by the second merchant, and the payout to the second merchant. The third merchant section 540 may include the cost of the products included in the consolidated order for the third merchant, the tax for the products, the tip for the third merchant, the portion of fees to be paid by the third merchant, and the payout to the third merchant.

The first merchant, the second merchant, and the third merchant may pay fixed fees and variable fees, and the first merchant, the second merchant, and the third merchant may divide the costs of some fees. For example, the first merchant, the second merchant, and the third merchant may pay a community fee equivalent to 3% of the sub total of products associated with the merchant included in the consolidated order. The first merchant, the second merchant, and the third merchant may pay a platform service fee equivalent to 5% of the sub total of products associated with the merchant included in the consolidated order. The first merchant, the second merchant, and the third merchant may pay a variable credit card fee equivalent to 2.9% of the sub total of products associated with the merchant included in the consolidated order and a share a $0.30 credit card fee evenly between the merchants.

The community may receive the community service fee from the user and the community fee from the first merchant, the second merchant, and the third merchant as shown in the community section 550. The consolidated ordering system 120 may receive all the fees, including the service fee, the platform service fee, the credit card fees, and the community fee as shown in the consolidated ordering system section 560. The consolidated ordering system 120 may distribute the fees (e.g., the community fees to the community) and keep the service fee and the platform service fee.

In some embodiments, fees can be shared evenly between merchants, shared based the on number of products from a merchant, and/or shared based on the total cost of products from a merchant. Additionally, the user may be charged a fee based on the number of merchants included in an order (e.g., $0.10 for two merchants, $0.20 for three merchants, $0.30 for four merchants, etc.).

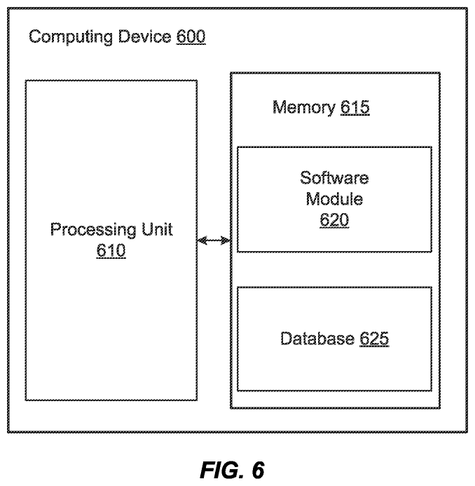

FIG. 6 is a block diagram of a computing device 600. As shown in FIG. 6, computing device 600 may include a processing unit 610 and a memory unit 615. The memory unit 615 may include a software module 620 and a database 625. While executing on the processing unit 610, the software module 620 may perform, for example, processes for providing consolidated ordering as described above with respect to FIG. 1, FIG. 2, FIG. 3, FIG. 4, and FIG. 5. The computing device 600, for example, may provide an operating environment for the user device 102, the first merchant device 104, the second merchant device 106, the delivery device 108, the consolidated ordering system 120, the merchant processor 122, the ordering processor 124, the payment processor 126, the delivery processor 128, the data processor 130, and/or any other system described herein. The user device 102, the first merchant device 104, the second merchant device 106, the delivery device 108, the consolidated ordering system 120, the merchant processor 122, the ordering processor 124, the payment processor 126, the delivery processor 128, the data processor 130, and/or any other system described herein may operate in other environments and are not limited to computing device 600.

Computing device 600 may be implemented using a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or some other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

1. A method for facilitating a consolidated order from a plurality of merchants, the method comprising:
providing a user interface including:
a first user interface view, the first user interface view including a first input for selecting a first product provided from a first merchant, and
a second user interface view, the second user interface view including a second input for selecting a second product provided from a second merchant;
receiving a first selection of the first input;
in response to the first selection, adding the first product to an order;
receiving a second selection of the second input;
in response to the second selection, adding the second product to the order;
determining a total cost for the order;
requesting payment for the total cost of the order;
receiving a payment for the total cost of the order;
in response to receiving the payment:
sending instructions for the order to be fulfilled, by the first merchant and the second merchant, and
sending delivery instructions for the products included in the order to be retrieved, by a delivery person, the delivery instructions including retrieving the first product from a first location where the first merchant is located and retrieving the second product from a second location where the second merchant is located;
disbursing a first portion of the payment to the first merchant; and
disbursing a second portion of the payment to the second merchant.

2. The method of claim 1, further comprising receiving a request for to access a consolidated ordering system, wherein providing the user interface is in response to receiving the request.

3. The method of claim 1, further comprising, based on the products included in the order:
determining the first portion of the payment for the first merchant; and
determining the second portion of the payment for the second merchant.

4. The method of claim 1, further comprising:
determining a fee associated with the order;
subtracting a first portion of the fee from the first portion of the payment prior to disbursing the first portion of the payment to the first merchant; and
subtracting a second portion of the fee from the second portion of the payment prior to disbursing the second portion of the payment to the second merchant.

5. The method of claim 4, wherein the first portion of the fee and the second portion of the fee are equivalent.

6. The method of claim 4, wherein the fee includes a user fee, a first merchant fee, and a second merchant fee.

7. The method of claim 1, wherein sending instructions for the order to be fulfilled comprises:
instructing the first merchant to prepare the first product; and
instructing the second merchant to prepare the second product.

8. The method of claim 1, wherein the first location and the second location are the same location.

9. The method of claim 1, further comprising:
displaying merchant buttons for the merchants, the merchant buttons selectable to cause only products associated with a selected merchant associated with a selected merchant button to be displayed.

10. The method of claim 9, wherein the merchant buttons include:
a first merchant button associated with the first merchant, the first merchant button selectable to provide the first user interface view; and
a second merchant button associated with the second merchant, the second merchant button selectable to provide the second user interface view.

11. A system for facilitating a consolidated order from a plurality of merchants comprising at least one processing device and at least one memory device, the memory device storing data instructions that, when executed by the at least one processing device, cause the at least one processing device to:
display on a computing device a consolidated order interface comprising:
a merchant button for each of a plurality of merchants, the merchant buttons selectable to cause a user device to display one or more product buttons, the product buttons associated with products of the selected merchant and selectable to add products to an order, and
an order button that is selectable to cause the user device to display an order interface comprising a list of selected products and a payment button to initiate a transaction for the selected products;
receive input selecting a first merchant button associated with a first merchant;
display a first product button associated with a first product of the first merchant in response to receiving the input selecting the first merchant button;
receive input selecting the first product button;
add the first product to the order in response to the input selecting the first product button;
receive input selecting a second merchant button associated with a second merchant;
display a second product button associated with a second product of the second merchant in response to receiving the input selecting the second merchant button;
receive input selecting the second product button;
add the second product to the order in response to the input selecting the second product button;
receive a payment for the order; and
send instructions for the order to be fulfilled in response to receiving the payment.

12. The system of claim 11, wherein the consolidated order interface further comprises one or more product type buttons that are selectable to cause the user device to display the product buttons associated with products of a selected product type.

13. The system of claim 11, wherein the at least one processing device is further configured to:
send delivery instructions for the products included in the order to be retrieved, by a delivery person, the delivery instructions including retrieving the first product from a first location where the first merchant is located and retrieving the second product from a second location where the second merchant is located.

14. The system of claim 11, wherein the at least one processing device is further configured to:
disburse a first portion of the payment to the first merchant; and
disburse a second portion of the payment to the second merchant.

15. The system of claim 14, wherein the at least one processing device is further configured to:
determine a fee associated with the order;
subtract a first portion of the fee from the first portion of the payment prior to disbursing the first portion of the payment to the first merchant; and
subtract a second portion of the fee from the second portion of the payment prior to disbursing the second portion of the payment to the second merchant.

16. The system of claim 15, wherein the fee includes any one of (i) a service fee, (ii) a community service fee, (iii) a platform service fee, (iv) a credit card fee, or (v) any combination of (i)-(iv).

17. The system of claim 11, wherein to send instructions for the order to be fulfilled comprises to:
instruct the first merchant to prepare the first product; and
instruct the second merchant to prepare the second product.

18. The system of claim 11, wherein the at least one processing device is further configured to:
receive a request, from the computing device, to access a consolidated ordering system, wherein to display on the computing device the consolidated order interface is in response to receiving the request.

19. The system of claim 18, wherein the at least one processing device is further configured to:
display a merchant user interface on a first merchant device associated with the first merchant, the merchant user interface device comprising one or more product type lists; and
receive a request to add the first product button to one of the one or more product type lists, wherein display the first product button is in response to the request to add the first product button.

20. The system of claim 19, wherein the merchant user interface further comprises:
an operating days element including day buttons selectable to select days of operation; and
an operating times element including time buttons selectable to select hours of operation.
